(19) United States
(12) Patent Application Publication
(10) Pub. No.: US 2012/0075080 A1
(43) Pub. Date: Mar. 29, 2012

(54) READER/WRITER CONTROL APPARATUS

(76) Inventor: Masayoshi Ohuchi, Tokyo (JP)

(21) Appl. No.: 13/229,958

(22) Filed: Sep. 12, 2011

(30) Foreign Application Priority Data
Sep. 27, 2010 (JP) 2010-214749

(51) Int. Cl. H04Q 5/22

(52) U.S. Cl. 340/10.51

(57) ABSTRACT

A reader/writer control apparatus includes a behavior correspondence table having recorded a plurality of pieces of control information including respectively a control item and a control content for the control item in association with a unique tag ID corresponding to each piece of the control information; a search portion for searching from the behavior correspondence table, the control information recorded in association with a tag ID read by a tag read/write processing portion from a special control tag configured by a special wireless IC tag for controlling the operation of a reader/writer including the tag read/write processing portion for reading and writing data from and to the wireless IC tag having recorded the unique tag ID corresponding to the control information; and a main processing portion for controlling the operation of the reader/writer according to the control information searched by the search portion.

### INCORPORATION BY REFERENCE

The present application claims priority from Japanese Patent Application No. 2010-214749, filed on Sep. 27, 2010 in Japan, the disclosure of which is incorporated herein by reference in its entirety.

### TECHNICAL FIELD

The present invention relates to a reader/writer control apparatus for controlling the operation of a reader/writer which reads and writes data from and to a wireless IC tag.

### BACKGROUND ART

In recent years, an authentication technique utilizing radio waves has become popular. It is called RFID (Radio Frequency Identification), and systems utilizing RFID have come in sight at various places in our daily lives. Because a system utilizing RFID can read and write data from and to a wireless IC tag in a noncontact manner through a radio wave emitted by the antenna of a reader/writer, over which the wireless IC tag only needs to pass, it becomes possible to carry out an efficient authentication in comparison with the authentication techniques utilizing barcodes and the like, which have been performed so far.

As shown in FIG. 14A for example, if a wireless IC tag is affixed to each authentication object, then only by outputting a radio wave from the antenna of a reader/writer (RW), it is possible to read the data about an authentication object from the wireless IC tag affixed to each authentication object. Thereby, an efficient authentication can be carried out in comparison with the authentication techniques utilizing barcodes and the like.

In reality however, there are cases that it becomes impossible to read the wireless IC tag affixed to an authentication object in operating the system. As shown in FIG. 14B for example, when the communication environment with the wireless IC tags has changed from that of initially operating the system, e.g., some obstacles have come in the way, the materials of the authentication objects have been changed to metals, and the like, then the wireless IC tags may no longer be readable. That is, when the current communication environment becomes out of accord with the various setting values for adjusting the communication condition with the wireless IC tags, which were set to the reader/writer at the beginning of operating the system (the intensity, beam angle and the like of the radio wave outputted from the antenna, for example), then the wireless IC tags can no longer be read. In such cases, although it is possible to make the wireless IC tags readable again by resetting the values to satisfy the current communication environment, since setting those values is generally performed manually by the user, there is a problem that a burden is imposed on the user.

On the other hand, as a technique for improving the rate of reading wireless IC tags, such is known as the following (see Patent Document 1, for example).

In the technique disclosed in Patent Document 1, the wireless IC tag affixed to an authentication object prerecords a tag ID denoting its type, a radio wave influence level denoting the degree of the influence from the authentication object on the radio wave outputted from the reader/writer, and object information denoting the ID and type of the authentication object. Further, since the tag ID and the radio wave influence level are multiply recorded in a wireless IC tag, they have a higher possibility to be read than the object information. On reading the tag ID and the radio wave influence level from a wireless IC tag, the reader/writer sends communication environment information including the above information and a reader/writer ID denoting the type of the reader/write itself to the server.

The server includes a database having recorded various setting values (predetermined setting values such as the intensity and beam angle of the radio wave, and the like) for adjusting the communication with the wireless tags to a good condition in multiple communication environments by associating each of the multiple communication environments with the communication environment information denoting the communication environment. Then, on receiving the communication environment information from the reader/writer, the server searches the various setting values recorded in association with the communication environment information from the database, and sends the search result to the reader/writer.

On receiving the various setting values from the server, the reader/writer adjusts the communication to a good condition by controlling each portion such that the intensity, beam angle and the like of the radio wave become the setting values, and then requests to read the object information from the wireless IC tag. If the reading is successful, then the reader/writer sends communication result information including a message informing the success, the current various setting values, and the communication environment information to the server. On the other hand, if the reading is unsuccessful, then it sends the communication result information including a message informing the failure and the communication environment information to the server.

Based on the communication result information sent from the reader/writer, the server updates the various setting values recorded in the database such that the communication condition with the wireless IC tag becomes better.

[Patent Document 1] JP 2007-94934 A

According the technique disclosed in Patent Document 1, it is possible to improve the rate of reading wireless IC tags by controlling the reader/writer without imposing a burden on the user. However, because the technique disclosed in Patent Document 1 controls the operation of a reader/writer by utilizing a wireless IC tag having recorded the object information for authenticating the authentication object, and the tag ID and radio wave influence level for controlling the operation the reader/writer, there is a problem that the timing allowed to control the operation of a reader/writer is limited to the moment of authenticating the authentication object.

### SUMMARY

In view of the above, an exemplary object of the present invention is to provide a reader/writer control apparatus for solving the above problem that the timing allowed to control the operation of a reader/writer is limited.

In order to achieve the above exemplary object, an aspect in accordance with the present invention provides a reader/writer control apparatus including: a behavior correspondence table having recorded a plurality of pieces of control information including respectively a control item and a control content for the control item in association with a unique tag ID corresponding to each piece of the control information; a search portion for searching from the behavior correspondence table, the control information recorded in association with a tag ID read by a tag read/write processing portion from a special control tag configured by a wireless IC tag having recorded the unique tag ID corresponding to the control information and being utilized for controlling the operation of a reader/writer including the tag read/write processing portion for reading and writing data from and to a wireless IC tag; and a processing portion for controlling the operation of the reader/writer according to the control information searched by the search portion.

Further, another aspect in accordance with the present invention provides a special control tag configured by a wireless IC tag which has recorded a unique tag ID corresponding to a control item and a control content for the control item, and which is utilized for controlling an operation of a reader/writer for reading and writing data from and to a wireless IC tag.

Further, still another aspect in accordance with the present invention provides a reader/writer control method for controlling an operation of a reader/writer including a tag read/write processing portion for reading and writing data from and to a wireless IC tag.

Further, the reader/writer control method includes: reading a tag ID from a special control tag configured by a wireless IC tag which has recorded a unique tag ID corresponding to control information including a control item and a control content for the control item, and which is utilized for controlling the operation of the reader/writer; searching the control information recorded in association with the tag ID read from the special control tag, in a behavior correspondence table having recorded a plurality of pieces of the control information in association with the unique tag ID corresponding to each piece of the control information; and controlling the operation of the reader/writer according to the searched control information.

Further, still another aspect in accordance with the present invention provides a computer-readable medium storing a program including instructions for causing a computer to carry out a process for controlling an operation of a reader/writer including a tag read/write processing portion for reading and writing data from and to a wireless IC tag.

Further, the above-described process includes: reading a tag ID from a special control tag configured by a wireless IC tag which has recorded a unique tag ID corresponding to control information including a control item and a control content for the control item, and which is utilized for controlling the operation of the reader/writer; searching the control information recorded in association with the tag ID read from the special control tag, in a behavior correspondence table having recorded a plurality of pieces of the control information in association with the unique tag ID corresponding to each piece of the control information; and controlling the operation of the reader/writer according to the searched control information.

According to the present invention, it is possible to acquire an effect of allowing an arbitrary timing to control the operation of a reader/writer by utilizing a wireless IC tag.

### BRIEF DESCRIPTION OF DRAWINGS

FIG. 1 is a block diagram showing a configuration example in accordance with a first exemplary embodiment of the present invention;

FIG. 2 shows an example of the behavior correspondence table 160;

FIG. 3 is a flowchart showing a processing example in accordance with the first exemplary embodiment of the present invention;

FIGS. 4A and 4B are diagrams for explaining a second exemplary embodiment of the present invention;

FIGS. 5A and 5B are diagrams for explaining a third exemplary embodiment of the present invention;

FIG. 6 is a block diagram showing a configuration example in accordance with a fourth exemplary embodiment of the present invention;

FIG. 7 is a diagram for explaining the fourth exemplary embodiment of the present invention;

FIG. 8 is a diagram for explaining a fifth exemplary embodiment of the present invention;

FIG. 9 is a diagram for explaining a sixth exemplary embodiment of the present invention;

FIG. 10 is a diagram for explaining a seventh exemplary embodiment of the present invention;

FIG. 11 is a flowchart showing a processing example in accordance with the seventh exemplary embodiment of the present invention;

FIG. 12 is a block diagram showing a configuration example in accordance with an eighth exemplary embodiment of the present invention;

FIGS. 13A to 13D are diagrams for explaining a ninth exemplary embodiment of the present invention; and

FIG. 14 is a diagram for explaining a background art.

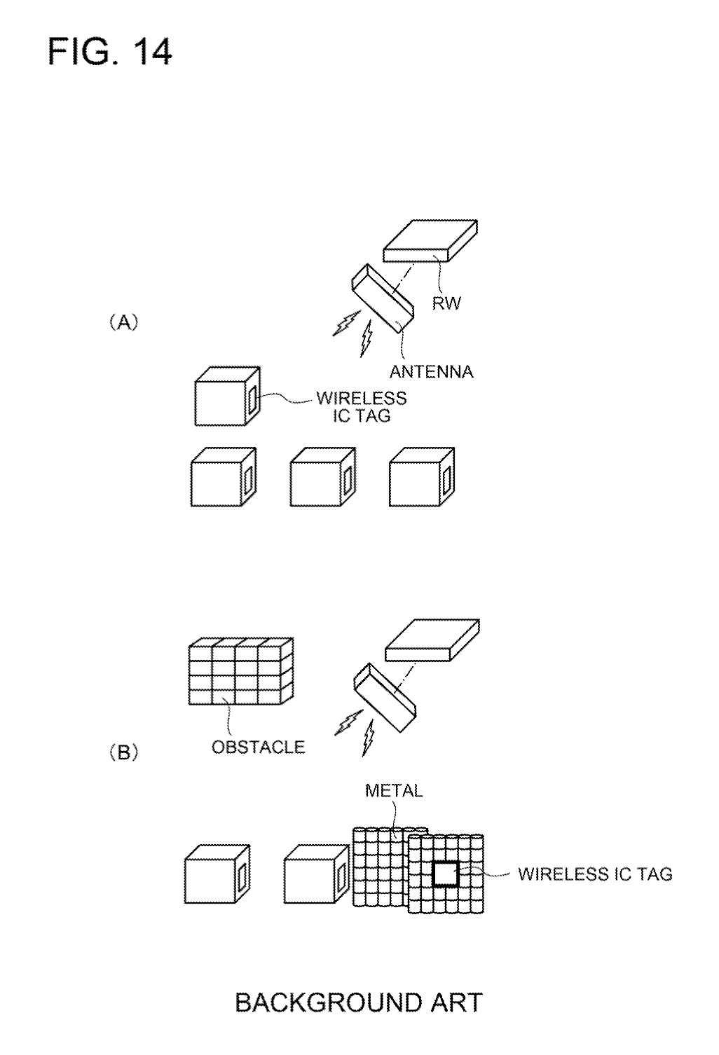

### EXEMPLARY EMBODIMENTS

### A First Exemplary Embodiment of the Present Invention

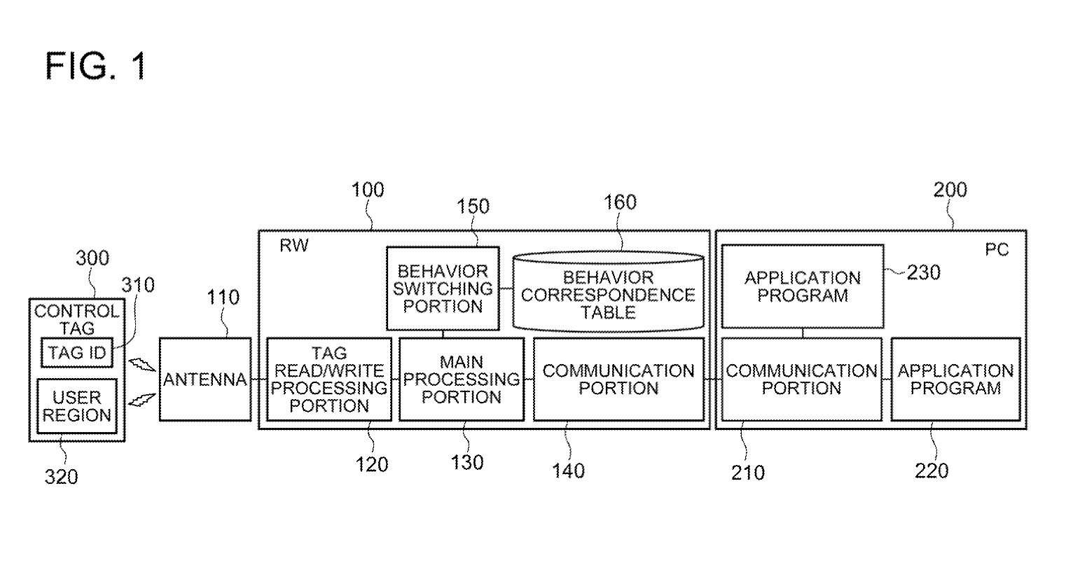

Referring to FIG. 1, a reader/writer control apparatus in accordance with a first exemplary embodiment of the present invention is composed of a reader/writer (RW) 100, a personal computer (PC) 200, and a control tag 300 utilized for controlling the operation of the reader/writer 100.

The control tag 300 is a special wireless IC tag utilized for controlling the operation (or behavior) of the reader/writer 100, and includes a tag ID region 310, and a user region 320 for recording data. The tag ID region 310 has recorded a tag ID corresponding to a control item and a control content for controlling the operation of the reader/writer 100. The control item denotes a control object such as the radio wave intensity, the party (destination) to be notified of data, the radio polarization mode, and the like. The control content is the information denoting how to set the state of a control object. For example, the control content for the control item “radio wave intensity” is a value such as “0” and the like, and the control content for the control item “the party to be notified of data” is a program name such as “application program AP1” and the like. Further, the control tag 300 has recorded a unique tag ID different from that recorded in a common wireless IC tag utilized for authenticating an authentication object.

The reader/writer 100 includes an antenna 110, a tag read/write processing portion 120, a main processing portion 130, a communication portion 140, a behavior switching portion 150, and a behavior correspondence table 160 recorded in a storage device such as disks and the like.

The tag read/write processing portion 120 reads and writes data from and to wireless IC tags (the control tag 300, a common wireless IC tag affixed to an authentication object, and the like) via the antenna 110. The main processing portion 130 controls each portion of the reader/writer 100. The communication portion 140 exchanges data with the personal computer 200.

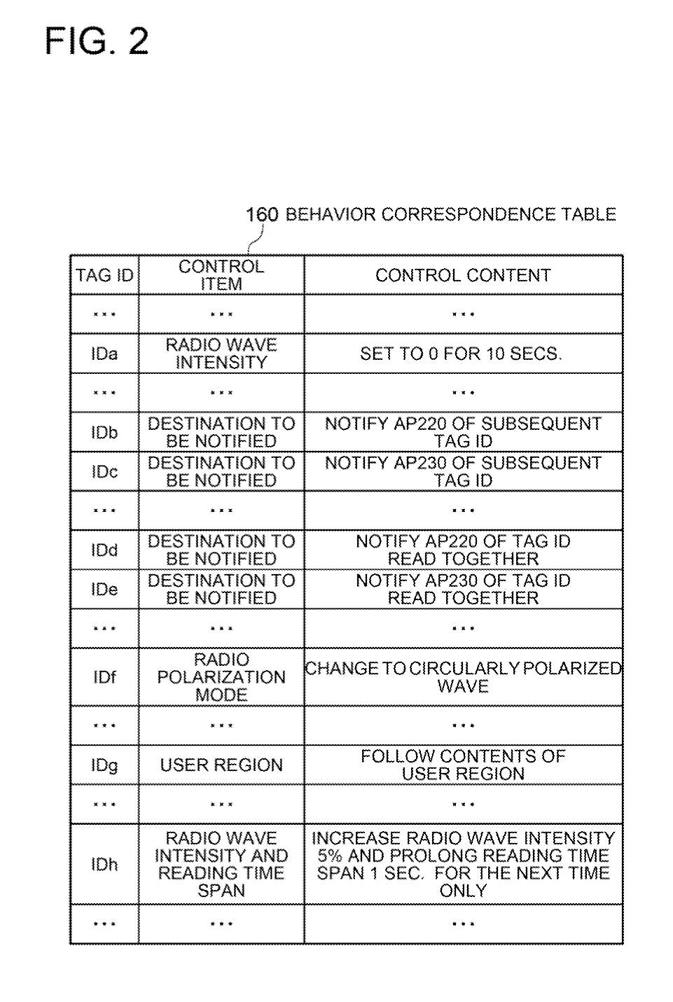

The behavior correspondence table 160 has recorded control information composed of the control item and the control content in association with each of a plurality of tag IDs for controlling the operation of the reader/writer 100. FIG. 2 shows an example of the behavior correspondence table 160, wherein because the control information recorded in association with the tag ID “IDa” has “radio wave intensity” as the control item, and “set to zero for 10 seconds” as the control content, for example, it is utilized for setting the radio wave intensity outputted from the reader/writer 100 to zero for 10 seconds. Further, for example too, because the control information recorded in association with the tag ID “IDf” has “radio polarization mode” as the control item, and “change to circularly polarized wave” as the control content, it is utilized for changing the radio polarization mode outputted from the reader/writer 100 to a circularly polarized wave. Further, the behavior correspondence table 160 has only recorded the tag ID recorded in a control tag 300 for controlling the operation of the reader/writer 100, but not recorded the tag ID recorded in a common wireless IC tag utilized for authenticating an authentication object. Further, although illustrations are omitted in FIG. 1, the reader/writer 100 internally includes a display unit for displaying the contents of the behavior correspondence table 160 according to user's instruction, and a modification unit for modifying the contents of the behavior correspondence table 160 according to user's instruction inputted from an input portion such as a keyboard and the like.

The behavior switching portion 150 has a function of searching the control information recorded in association with the tag ID read from the control tag 300 from the behavior correspondence table 160, passing the searched control information to the main processing portion 130, and the like.

Further, it is possible to realize the tag read/write processing portion 120, the main processing portion 130, the communication portion 140, and the behavior switching portion 150 by means of a CPU (Central Processing Unit) and, in such a case, for example, the following configuration is applicable. A disk or semiconductor memory is prepared to record a computer program for making the CPU function as the tag read/write processing portion 120, the main processing portion 130, the communication portion 140, and the behavior switching portion 150, and causing the CPU to read the program. By controlling its own operation according to the read program, the CPU realizes on its own the tag read/write processing portion 120, the main processing portion 130, the communication portion 140, and the behavior switching portion 150.

The personal computer 200 includes a communication portion 210, and application programs 220 and 230 to operate on the CPU, the illustration of which is omitted.

The communication portion 210 exchanges data with the reader/writer 100.

### An Explanation on the Behavior of the First Exemplary Embodiment

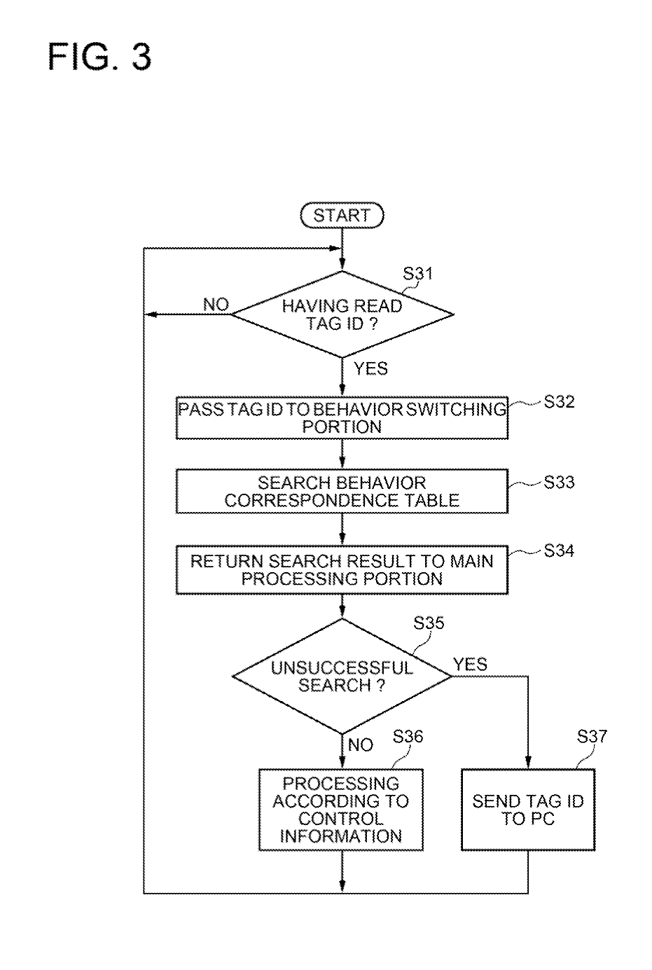

Next, referring to the flowchart of FIG. 3, the behavior of the first exemplary embodiment will be explained in detail.

In order to control the operation of the reader/writer 100, the user passes the control tag 300 corresponding to the control item and control content over the antenna 110 of the reader/writer 100. For example, when the contents of the behavior correspondence table 160 are those shown in FIG. 2, the user passes a control tag having recorded the tag ID “IDa” in the tag ID region 310 over the antenna 110 to set the radio wave intensity outputted from the reader/writer 100 to zero for 10 seconds, and passes a control tag having recorded the tag ID “IDf” over the antenna 110 to change the radio polarization mode to a circularly polarized wave.

On reading the tag ID recorded in the control tag 300 via the antenna 110 and the tag read/write processing portion 120, the main processing portion 130 in the reader/writer 100 passes the read tag ID to the behavior switching portion 150 (the step S31 in FIG. 3 is YES, then proceeding to S32).

Then, the behavior switching portion 150 searches the control information recorded in association with the tag ID passed from the main processing portion 130 from the behavior correspondence table 160, and returns the search result to the main processing portion 130 (the steps S33 and S34). More particularly, it returns a search result denoting an unsuccessful search to the main processing portion 130 when the corresponding control information could not be found, or a search result including the found control information to the main processing portion 130 when the corresponding control information was found. In this example, since the tag ID is read from the control tag 300, the corresponding control information is searched. However, if the tag ID is read from a common wireless IC tag for authenticating an authentication object, then the corresponding control information cannot be searched.

When a search result including control information is returned, the main processing portion 130 controls operation of the reader/writer 100 according to the control information (the step S35 is NO, then proceeding to S36). On the other hand, when a search result denoting an unsuccessful search is returned, this means that the tag ID was read from a common wireless IC tag for authenticating an authentication object; the tag ID is therefore sent to the personal computer 200 via the communication portion 140 (the step S35 is YES, then proceeding to S37). Further, in the case of sending the tag ID to the personal computer 200, the main processing portion 130 adds information for denoting the party to be notified to the tag ID.

### An Effect of the First Exemplary Embodiment

According to the first exemplary embodiment, it is possible to control the operation of the reader/writer 100 with any timing by utilizing a wireless IC tag. This is because the operation of the reader/writer 100 is controlled by utilizing the control tag 300 configured by a wireless IC tag which has recorded a unique tag ID corresponding to a control item and a control content for the control item, but not recorded authentication data for authenticating an authentication object.

Further, according to the first exemplary embodiment, it is possible to control various control items of the reader/writer 100. This is because the behavior correspondence table 160 is provided to have recorded a plurality of pieces of control information with control items different from each other in respective association with tag IDs corresponding to the combination of a control item and a control content in the control information.

### A Second Exemplary Embodiment of the Present Invention

Next, a second exemplary embodiment of the present invention will be explained in detail.

It is confirmed that radio waves emitted by RFID readers/writers affect pacemakers. Hence, in the places where a reader/writer is utilized, it is required that a special sticker should be pasted at a position visible by pacemaker users. In addition, it is advised that pacemaker users should not get within 22 cm (or 1 m, depending on the wave band) from the antenna of a reader/writer, or not stay near a reader/writer for a long time.

In reality however, the radio wave emitted by an RFID reader/writer cannot be visually confirmed and, moreover, although a special sticker is pasted, it is also possible to be unnoticed. Therefore, there is a conceivable risk that pacemaker users unknowingly get within the range under the radio wave influence. For example, since it is conceivable for a gate system used in entrance and exit management to utilize readers/writers at places where people have to pass, it is necessary to take some precautionary measures. In the second exemplary embodiment, the above problem is solved by applying the reader/writer control apparatus in accordance with the present invention to a gate system.

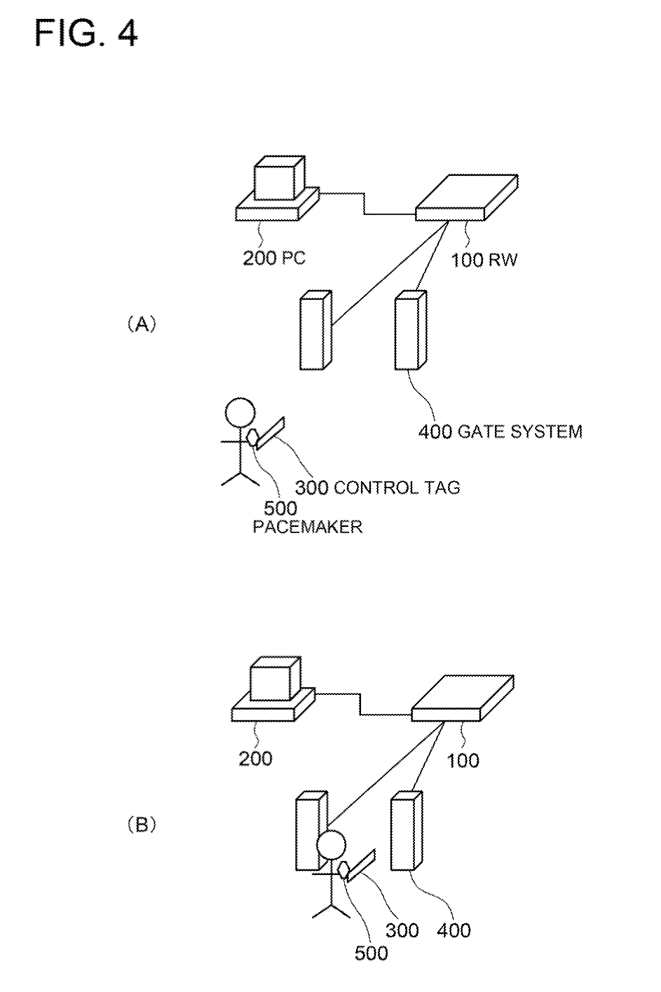

Referring to FIG. 4A, the second exemplary embodiment includes the reader/writer 100, the personal computer 200 and the control tag 300 which have the configuration shown in FIG. 1, and a gate system 400.

The gate system 400 is a system for opening the gate for a predetermined period of time as the reader/writer 100 reads, the tag ID from the control tag 300 or from a common wireless IC tag for authenticating an authentication object. In the second exemplary embodiment, on reading the tag ID from the control tag 300 or from a common wireless IC tag for authenticating an authentication object (not shown) via the antenna 110 and the tag read/write processing portion 120, the main processing portion 130 in the reader/writer 100 instructs the gate system 400 to open the gate for a predetermined period of time. By virtue of this, the gate system 400 opens the gate for the predetermined period of time.

Further, an authentication object in the second exemplary embodiment is a person or an article. A person passing through the gate carries a wireless IC tag having recorded a staff number and the like as the tag ID, while an article passing through the gate has an affixed wireless IC tag having recorded article information for specifying the article as the tag ID. Further, a user of a pacemaker 500 carries a special control tag 300 for stopping the output of radio wave from the reader/writer 100. In particular, if the contents of the behavior correspondence table 160 are those shown in FIG. 2, then the user of the pacemaker 500 carries the control tag 300 having recorded “IDa” as the tag ID.

### An Explanation on the Behavior of the Second Exemplary Embodiment

Next, the behavior of the second exemplary embodiment will be explained.

As shown in FIG. 4B, when the user of the pacemaker 500 comes within the radio wave range of the reader/writer 100 (the range in which the tag ID can be read from a wireless IC tag; it may also be referred to as the reading range), the main processing portion 130 reads in the tag ID “IDa” of the control tag 300 carried by the user for stopping the output of radio wave via the antenna 110 and the tag read/write processing portion 120, and passes the read tag ID “IDa” to the behavior switching portion 150 (the step S31 in FIG. 3 is YES, then proceeding to S32). Further, in the step S32, the main processing portion 130 instructs the gate system 400 to “open the gate”.

The behavior switching portion 150 searches the control information recorded in association with the tag ID “IDa” passed from the main processing portion 130 from the behavior correspondence table 160, and returns the search result to the main processing portion 130 (the steps S33 and S34). In this example, it returns the search result including the control information with the control item and the control content being “radio wave intensity” and “set to zero for 10 seconds”, respectively, to the main processing portion 130.

On receiving the search result from the behavior switching portion 150, the main processing portion 130 accordingly controls each portion of the apparatus to stop the output of radio wave from the reader/writer 100 for 10 seconds of time and, thereafter, restarts the normal operation (the step S35 is NO, then proceeding to S36). By virtue of this, if the user of the pacemaker 500 gets within the radio wave reading range without realizing that the reader/writer 100 is installed, because the radio wave output from the reader/writer 100 will automatically stop, it is possible to avoid the influence on the pacemaker 500 due to the radio wave outputted from the reader/writer 100.

The above process is carried out when the reader/writer 100 has read the tag ID recorded in the control tag 300. On the other hand, the following process is carried out when it has read the tag ID from a wireless IC tag for authentication affixed to an authentication object (person or article).

When the reader/writer 100 has read the tag ID from a wireless IC tag for authentication, the aforementioned process of the steps S31 to S34 is carried out. As described hereinabove, since the tag ID recorded in a wireless IC tag for authentication is not recorded in the behavior correspondence table 160, the behavior switching portion 150 returns a search result denoting an unsuccessful search to the main processing portion 130.

On receiving the search result denoting an unsuccessful search, the main processing portion 130 sends the tag ID read from a wireless IC tag for authentication to the personal computer 200 (the step S37). At the time, the main processing portion 130 adds the information denoting the application program 220 as the party to be notified (the program name, for example) to the tag ID read from a wireless IC tag carried by a person, but adds the information denoting the application program 230 as the party to be notified to the tag ID read from a wireless IC tag affixed to an article. Further, the tag ID includes information for distinguish whether the tag ID is recorded in a wireless IC tag carried by a person or recorded in a wireless IC tag affixed to an article. Based on this information, the main processing portion 130 determines the party to be notified for the tag ID.

On receiving a tag ID from the reader/writer 100, the communication portion 210 in the personal computer 200 passes the tag ID to the application program 220 or the application program 230 according to the information added thereto denoting the party to be notified. On receiving the tag ID passed from the communication portion 210, the application program 220 or 230 carries out a process to record the same into a storage device, etc.

Further, in the above explanation, the control tag 300 is supposed to be carried by a user of the pacemaker 500. However, the control tag 300 may as well be carried by users who carry devices with a possibility of malfunction caused by the radio wave influence such as other medical devices, delicate equipment, and the like.

### An Effect of the Second Exemplary Embodiment

According to the second exemplary embodiment, in addition to the effect acquired in the first exemplary embodiment, it is possible to acquire another effect that when users carrying devices with a possibility of malfunction caused by the radio wave influence such as the pacemaker 500 and the like come within the radio wave range of the reader/writer 100, the radio wave output from the reader/writer 100 can be stopped to prevent malfunction. This is because the behavior correspondence table 160 has recorded the control information for setting the radio wave intensity outputted from the reader/writer 100 to zero.

### A Third Exemplary Embodiment of the Present Invention

Next, a third exemplary embodiment of the present invention will be explained in detail. In the same manner as the second exemplary embodiment described hereinabove, the third exemplary embodiment applies the reader/writer control apparatus in accordance with the present invention to a gate system, and is characterized by the aspect of restarting the output of radio wave from the reader/writer when determining that the pacemaker user has been out of the radio wave range of the reader/writer based on an imaging result by a camera.

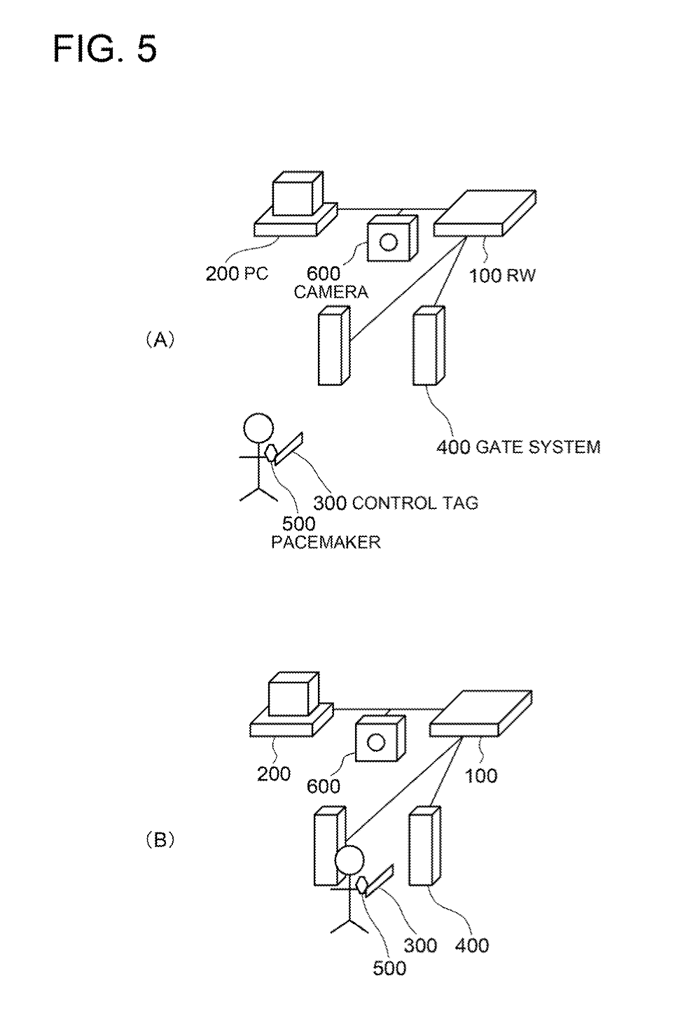

Referring to FIG. 5A, the gate system of the third exemplary embodiment differs, from that of the aforementioned second exemplary embodiment in the aspect of including a camera 600. The imaging range of the camera 600 is almost equal to the radio wave range of the reader/writer 100, and thus possible to take the image of a person within the radio wave range.

### An Explanation on the Behavior of the Third Exemplary Embodiment

Next, the behavior of the third exemplary embodiment will be explained. A user of the pacemaker 500 carries the control tag 300 for stopping the output of radio wave from the reader/writer 100. In the third exemplary embodiment, the control tag 300 has recorded the tag ID “IDa”, and the behavior correspondence table 160 has recorded the control information with the control item and the control content being “radio wave intensity” and “set to zero”, respectively, in association with the tag ID “IDa” as the control information for stopping the output of radio wave from the reader/writer 100.

When the user of the pacemaker 500 comes within the radio wave range of the reader/writer 100, the same process is carried out as the steps S31 to S34 of FIG. 3, and a search result is passed from the behavior switching portion 150 to the main processing portion 130. In this example, the search result includes the control information with the control item being “radio wave intensity” and the control content being “set to zero”.

By virtue of this, the main processing portion 130 controls each portion of the reader/writer 100 to set the radio wave intensity outputted from the reader/writer 100 to zero (the step S35 is NO, then proceeding to S36). Further, the main processing portion 130 starts up the camera 600 in the step S36. By virtue of this, the camera 600 takes an image for the radio wave range of the reader/writer 100, and sends an image signal to the personal computer 200.

The personal computer 200 includes a person presence determination portion (not shown) for determining whether there is a person image in the image denoted by the image signal sent from the camera 600. When the user of the pacemaker 500 is within the radio wave range of the reader/writer 100, there is a person image in the above image, whereas when the user is out of the radio wave range, there is no longer a person image in the above image. If there is no longer a person image in the image, then the person presence determination portion outputs a restart instruction to the reader/writer 100. That is, after the user of the pacemaker 500 gets out of the radio wave range of the reader/writer 100, the person presence determination portion outputs a restart instruction to the reader/writer 100.

On receiving a restart instruction from the personal computer 200, the main processing portion 130 in the reader/writer 100 controls each portion to restart the output of the stopped radio wave, and restores the normal operation.

### An Effect of the Third Exemplary Embodiment

According to the third exemplary embodiment, in addition to the effect acquired in the second exemplary embodiment, it is possible to acquire another effect that during the period that a user of the pacemaker 500 is within the radio wave range of the reader/writer 100, it is possible to reliably stop the output of radio wave from the reader/writer 100. This is because a person presence determination portion is provided to determine whether there is a person within the radio wave range based on an image signal outputted from the camera 600 serving to take images for the radio wave range of the reader/writer 100.

### A Fourth Exemplary Embodiment of the Present Invention

Next, a fourth exemplary embodiment of the present invention will be explained in detail. The fourth exemplary embodiment allows one reader/writer to be shared by a plurality of different application programs.

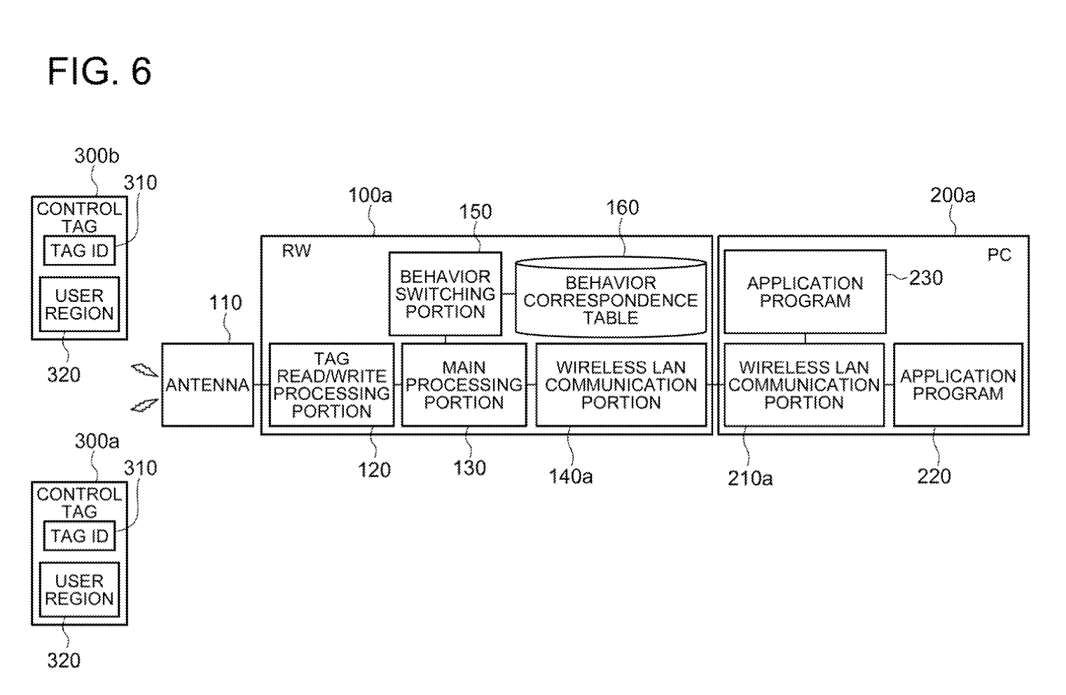

Referring to FIG. 6, a reader/writer control apparatus in accordance with the fourth exemplary embodiment includes a reader/writer 100a, a personal computer 200a, and control tags 300a and 300b.

The reader/writer 100a of the fourth exemplary embodiment differs from the reader/writer 100 of the first exemplary embodiment shown in FIG. 1 in the aspects of being a portable handheld reader/writer, and including a wireless LAN communication portion 140a, instead of the communication portion 140, for exchanging data with the personal computer 200a by a wireless LAN. Further, the personal computer 200a differs from the personal computer 200 of the first exemplary embodiment shown in FIG. 1 in the aspect of including a wireless LAN communication portion 210a, instead of the communication portion 210, for exchanging data with the reader/writer 100a by the wireless LAN.

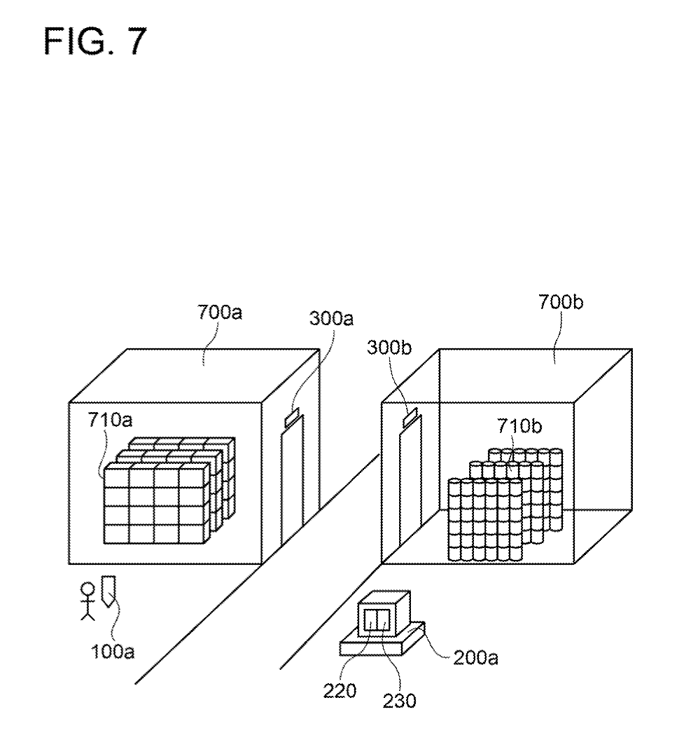

The control tags 300a and 300b include a tag ID region 310 and a user region 320 for recording data, respectively. In the fourth exemplary embodiment, the tag ID regions 310 of the control tags 300a and 300b have recorded tag IDs “IDb” and “IDc”, respectively. Further, as shown in FIG. 2, the behavior correspondence table 160 has recorded the control item “the party to be notified” and the control content “notify AP220 of the subsequent tag ID” in association with the tag ID “IDb”, and the control item “the party to be notified” and the control content “notify AP230 of the subsequent tag ID” in association with the tag ID “IDc”. Further, the control tags 300a and 300b are, as shown in FIG. 7, affixed above the doorways of warehouses 700a and 700b, respectively.

### An Explanation on the Behavior of the Fourth Exemplary Embodiment

A worker carrying the handheld reader/writer 100a utilizes it to carry out the checking of outbound articles for a product family 710a stored in the warehouse 700a, and the checking of inbound articles for a product family 710b stored in the warehouse 700b. Although either of the checking tasks performed by the worker is to utilize the reader/writer 100a to read the tag ID from the wireless IC tag for authentication affixed to an article, the application program to be notified is different from each other. In the fourth exemplary embodiment, the application programs 220 and 230 are to be notified of the tag IDs read from the wireless IC tags affixed to the articles in the warehouses 700a and 700b, respectively.

Under such conditions, when the worker enters the warehouse 700a, the main processing portion 130 of the reader/writer 100a reads the tag ID “IDb” recorded in the control tag 300a via the antenna 110 and the tag read/write processing portion 120, and passes the same to the behavior switching portion 150 (the step S31 is YES, then proceeding to S32). By virtue of this, the behavior switching portion 150 searches the control information recorded in association with the tag ID “IDb” from the behavior correspondence table 160, and returns the search result to the main processing portion 130 (the steps S33 and S34). In this example, the search result includes the control information with the control item “the party to be notified” and the control content “notify AP220 of the subsequent tag ID”.

The main processing portion 130 controls each portion according to the control information in the search result sent from the behavior switching portion 150, and sets the party to be notified of the tag ID read from a wireless IC tag for authentication to the application program 220 (the step S35 is NO, then proceeding to S36).

Thereafter, the worker utilizes the reader/writer 100a to carry out the reading of the wireless IC tags for authentication affixed to the articles in the warehouse 700a. On reading the tag ID from a wireless IC tag, the main processing portion 130 in the reader/writer 100a passes the same to the behavior switching portion 150 (the step S31 is YES, then proceeding to S32). By virtue of this, the behavior switching portion 150 searches the control information recorded in association with the tag ID from the behavior correspondence table 160, and returns the search result to the main processing portion 130 (the steps S33 and S34). As described hereinbefore, since the behavior correspondence table 160 has not recorded the tag ID of a wireless IC tag for authentication, the search result denotes an unsuccessful search.

On receiving the search result denoting an unsuccessful search from the behavior switching portion 150, the main processing portion 130 notifies the application program 220 of the tag ID read from the wireless IC tag because the party to be notified was set to the application program 220 in the aforementioned step S36 (the step S35 is YES, then proceeding to S37). Any method can be utilized to set the party to be notified to the application program 220. For example, it is possible to adopt a method for adding identification information such as the program name of the application program 220 and the like to the tag ID as the information denoting the party to be notified.

Further, when the worker enters the warehouse 700b to carry out the checking of inbound articles, in order for the reader/writer 100a to read the tag ID “IDc” from the control tag 300b affixed above the doorway, the party to be notified of the tag ID is set to the application program 230 (the step S31 is YES, then proceeding to S32 through S34; the step S35 is NO, then proceeding to S36).

### An Effect of the Fourth Exemplary Embodiment

According to the fourth exemplary embodiment, in addition to the effect acquired in the first exemplary embodiment, it is possible to acquire another effect that one reader/writer 100a can be shared by multiple application programs 220 and 230. This is because the behavior correspondence table 160 has recorded the control information for changing the party to be notified of the tag ID read from a wireless IC tag.

### A Fifth Exemplary Embodiment of the Present Invention

Next, a fifth exemplary embodiment of the present invention will be explained. In the same manner as the fourth exemplary embodiment, the fifth exemplary embodiment also allows one reader/writer to be shared by a plurality of different application programs. However, it differs from the fourth exemplary embodiment in the aspect of enabling a control tag to be effective only at the moment that the reader/writer has read the control tag.

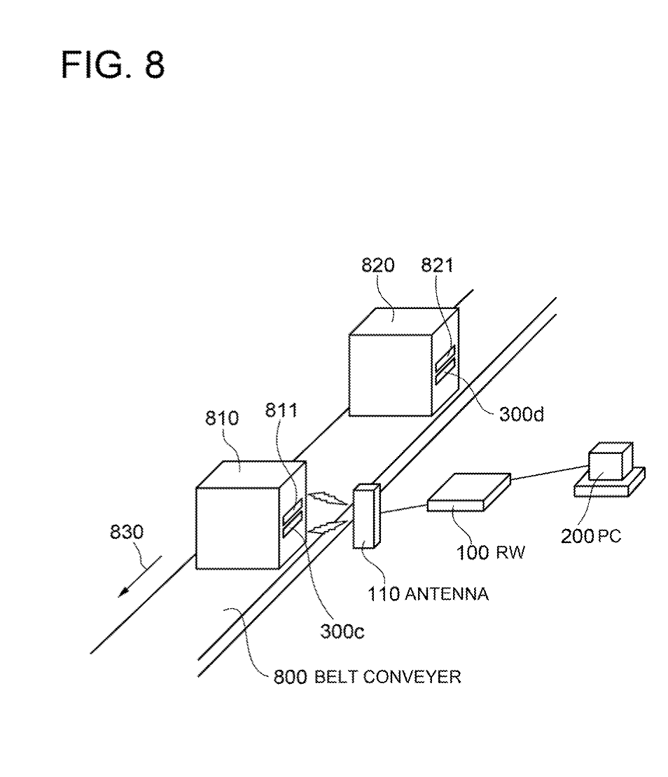

Referring to FIG. 8, wireless IC tags 811 and 821 for authentication, and control tags 300c and 300d for controlling the operation of the reader/writer 100 are affixed to cardboard boxes 810 and 820 conveyed by a belt conveyer 800, respectively. Further, in the vicinity of the belt conveyer 800, the antenna 110 of the reader/writer 100 is disposed to be able to read the tag ID from the wireless IC tags and control tags affixed to the cardboard boxes 810 and 820. Various types of products are contained in the cardboard boxes 810 and 820, and the reader/writer 100 notifies the application program in agreement with the type of the products contained in the cardboard boxes 810 and 820 of the tag ID read from the wireless IC tags 811 and 821 affixed to the cardboard boxes 810 and 820. Since the cardboard boxes 810 and 820 contain different types of products, the application program 220 should be notified of the tag ID read from the wireless IC tag 811 affixed to the cardboard box 810, while the application program 230 should be notified of the tag ID read from the wireless IC tag 821 affixed to the cardboard box 820. Further, the control tags 300c and 300d are supposed to have recorded tag IDs “IDd” and “IDe”, respectively. Further, as shown in FIG. 2, the behavior correspondence table 160 has recorded the control information with the control item “the party to be notified” and the control content “notify AP220 of the tag ID read together” in association with the tag ID “IDd”, and the control information of the control item “the party to be notified” and the control content “notify AP230 of the tag ID read together” in association with the tag ID “IDe”.

### An Explanation on the Behavior of the Fifth Exemplary Embodiment

Next, the behavior of the fifth exemplary embodiment will be explained in detail.

As the belt conveyer 800 conveys the cardboard box 810 in the direction along the arrow mark 830 to come within the radio wave range of the reader/writer 100, the main processing portion 130 of the reader/writer 100 reads the tag IDs from both of the wireless IC tag 811 and control tag 300c affixed in a pair to the cardboard box 810 via the antenna 110 and the tag read/write processing portion 120, and passes the two read tag IDs to the behavior switching portion 150. Further, in order to reliably carry out the reading of the wireless IC tag and control tag affixed to the cardboard boxes, a detection unit such as an infrared sensor may be set up in the vicinity of the belt conveyer 800 to detect whether a cardboard box has come within the radio wave range of the reader/writer 100. In the case that the reader/writer 100 cannot read the tag IDs recorded in the wireless IC tag and control tag even though the detection unit has detected a cardboard box, the belt conveyer 800 can be slowed down in terms of the conveyance speed or be stopped for a certain period of time.

The behavior switching portion 150 searches the control information recorded in association with the tag ID from the behavior correspondence table 160 for each of the two tag IDs passed from the main processing portion 130, and returns the search result to the main processing portion 130. In this case, the search result for the tag ID read from the wireless IC tag 811 denotes an unsuccessful search, while the search result for the tag ID “IDc” read from the control tag 300c includes the control information with the control item “the party to be notified” and the control content “notify AP220 of the tag ID read together”. According to this control information, the main processing portion 130 of the reader/writer 100 notifies the application program 220 on the personal computer 200 of the tag ID read from the wireless IC tag 811.

Further, in the case of reading the tag IDs at the same time from the wireless IC tag 821 and control tag 300d affixed to the cardboard box 820, too, the same process as that described hereinabove is carried out, and the application program 230 on the personal computer 200 is notified of the tag ID read from the wireless IC tag 821.

### An Effect of the Fifth Exemplary Embodiment

According to the fifth exemplary embodiment, in addition to the effect acquired in the first exemplary embodiment, it is possible to acquire another effect that one reader/writer 100 can be shared by a plurality of different application programs. This is because the behavior correspondence table 160 has recorded the control information for changing the party to be notified of the tag ID read from a wireless IC tag.

### A Sixth Exemplary Embodiment of the Present Invention

Next, a sixth exemplary embodiment of the present invention will be explained. The sixth exemplary embodiment utilizes a handheld reader/writer to efficiently read wireless IC tags for authentication affixed to all assets with as less power consumption as possible for taking inventory of the assets in a warehouse.

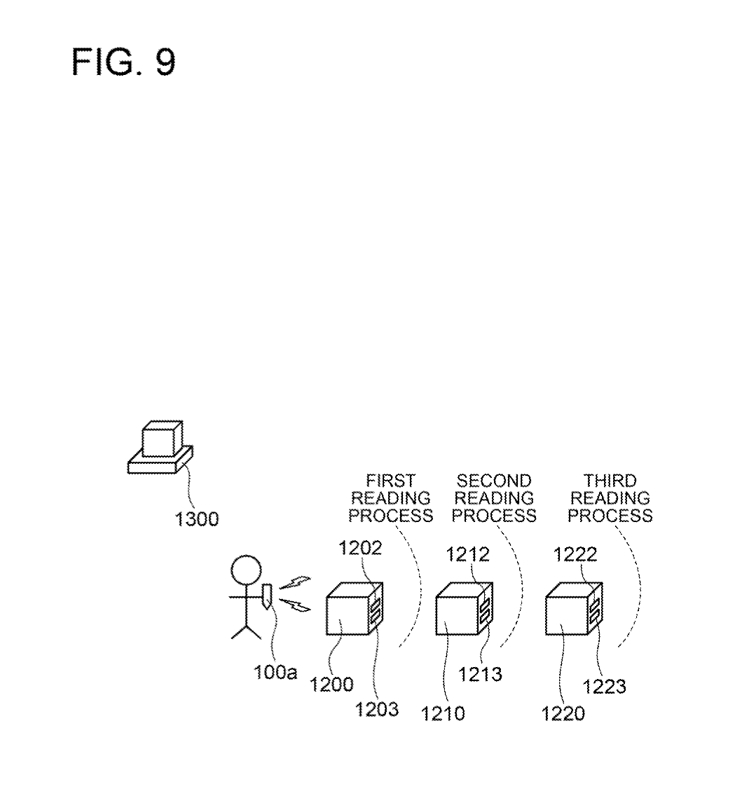

In the case of utilizing a handheld reader/writer to take inventory, commonly, the worker holding the reader/writer carries out the checking of the assets by reading the wireless IC tag affixed locally to an item of the assets while moving around in the warehouse. However, because the worker has to move around in the warehouse, this method has a risk that some items may be left unread, and a problem that it takes much time and labor. The sixth exemplary embodiment has solved such problems, and will be explained hereinbelow in reference to FIG. 9.

Referring to FIG. 9, a plurality of assets 1200, 1210 and 1220 are placed on a rack in the warehouse, and to the assets are affixed wireless IC tags 1202, 1212 and 1222 having recorded an asset ID to uniquely distinguish one asset from another, and control tags 1203, 1213 and 1223 to control a reader/writer 100a, respectively. The reader/writer 100a has the configuration shown in FIG. 6. It sends the asset ID read from a wireless IC tag via a wireless LAN to an asset management system 1300 set up at a separated place. The asset management system 1300 is realized by a computer, and carries out an inventory process based on the asset ID sent from the reader/writer 100a.

The control tags 1203, 1213, and 1223 have recorded a tag ID (as the ID “IDh”) corresponding to the combination of the control item “radio wave intensity and reading time span” and the control content “increase radio wave intensity 5% and prolong reading time span 1 second for the next time only”. Further, as shown in FIG. 2, the behavior correspondence table 160 in the reader/writer 100a has recorded the control information including the control item “radio wave intensity and reading time span” and the control content “increase radio wave intensity 5% and prolong reading time span 1 second for the next time only” in association with the tag ID “IDh”.

### An Explanation on the Behavior of the Sixth Exemplary Embodiment

Next, the behavior of the sixth exemplary embodiment will be explained in detail. Further, in the initial state, the radio wave intensity of the reader/writer 100 is set at a very low level so as to allow the device to read only the wireless IC tag and control tag affixed to the asset (the asset 1200 in the example, of FIG. 9) which is closest to the worker. Further, the reading time span, which is the reading time period for reading a wireless IC tag, is set at a very short period so as to allow the device to detect only the wireless IC tag and control tag affixed to the asset which is closest to the worker.

In the first reading process, the reader/writer 100a reads the asset ID from the wireless IC tag 1202 affixed to the closest asset 1200, and the tag ID “IDh” from the control tag 1203. The reader/writer 100a sends the asset ID to the asset management system 1300 by the wireless LAN. Further, the behavior switching portion 150 in the reader/writer 100a searches the control information recorded in association with the tag ID “IDh” from the behavior correspondence table 160, and passes the search result including the control item “radio wave intensity and reading time span” and the control content “increase radio wave intensity 5% and prolong reading time span 1 second for the next time only” to the main processing portion 130. By virtue of this, the main processing portion 130 controls each portion to increase the radio wave intensity by 5% and prolong the reading time span by one second in comparison with the initial state for the next reading process.

In the second reading process, by virtue of the performance of the control tag 1203 read in the first reading process, the radio wave intensity is increased by 5% and the reading time span is prolonged by one second in comparison with the initial state. Thereby, it is possible to read the wireless IC tags 1202 and 1212, and the control tags 1203 and 1213 affixed respectively to the closest asset 1200 and the adjacent asset 1210.

The reader/writer 100a sends the asset IDs read from the wireless IC tags 1202 and 1212 to the asset management system 1300. Further, because the reader/writer 100a has read two control tags 1203 and 1213, these two control tags 1203 and 1213 are both considered effective. In particular, on reading the tag ID “IDh” each time from the control tags 1203 and 1213, the main processing portion 130 of the reader/writer 100a passes the same to the behavior switching portion 150, while on receiving the tag ID “IDh” each time passed over, the behavior switching portion 150 returns the search result including the control item “radio wave intensity and reading time span” and the control content “increase radio wave intensity 5% and prolong reading time span 1 second for the next time only” to the main processing portion 130. By virtue of this, the main processing portion 130 controls each portion of the reader/writer 100a to increase another 5% on the radio wave intensity which has already been increased by 5% from the initial state, and prolong the reading time span by two seconds from the initial state for the next reading process.

In the third reading process, because the radio wave intensity of the reader/writer 100a is further increased and the reading time span is further prolonged from the second reading process, it is possible to read the wireless IC tags 1202, 1.212 and 1223, and the control tags 1203, 1213 and 1223 affixed respectively to the assets 1200 and 1210 and, in addition, the adjacent asset 1220.

By repeating such a process until no control tag can be newly read, the radio wave output and reading time span of the reader/writer 100a are increased accordingly. As a result, it is possible to check out all assets in the warehouse with the minimum requisite radio wave intensity (minimum requisite power consumption) and the shortest reading time span for reading the wireless IC tags and control tags affixed to all the assets.

Here, because it is conceivable that the assets are of various sizes, shapes and materials, the parameters for the reader/writer to change the control tag affixed to an asset may as well be modified in terms of the ratio such as from 5% to 10%, from one second to two second, and the like, so as to take into account the influence from the shape and material on the radio wave. Further, these values may also be modified in terms of disposition such as expanding the space between the assets, and the like.

Further, in the sixth exemplary embodiment, a portable handheld reader/writer 100a has been utilized. However, a stationary reader/writer 100 as shown in FIG. 1 may as well be utilized instead. Further, in the sixth exemplary embodiment, the reading process is repeated until no control tag can be newly read while increasing the radio wave intensity and the reading time span. However, the reading process may as well be repeated until having read the same number of the wireless IC tags as the number of the known assets in the warehouse. Further, in addition to the control tag for controlling the radio wave intensity and reading time span, by affixing to each asset a control ID for controlling the party to be notified of the asset ID read from a wireless IC tag for authentication, it is also possible to notify the party corresponding to an asset (an application program, for example) of the asset ID read from the wireless IC tag affixed to each asset.

### An Effect of the Sixth Exemplary Embodiment

According to the sixth exemplary embodiment, in addition to the effect acquired in the first exemplary embodiment, it is possible to acquire another effect that it is possible to efficiently read the wireless IC tags for authentication affixed to all assets with as less power consumption as possible in the case of taking inventory for the assets in the warehouse. This is because the behavior correspondence table 160 has recorded the control information for increasing the radio wave intensity and reading time span for the next reading process.

### A Seventh Exemplary Embodiment of the Present Invention

Next, a seventh exemplary embodiment of the present invention will be explained. The seventh exemplary embodiment utilizes a control tag to control the radio polarization mode of a reader/writer.

The rate of reading wireless IC tags by a reader/writer varies with the shape or direction of a tag, as well as with the radio wave type (circularly polarized wave, linearly polarized wave, and the like) emanating from the reader/writer. For example, for a card-type wireless IC tag, because the efficiency of receiving a radio wave becomes the best as the radio wave passes vertically through the card plane, the reading rate becomes the highest at that time. However, since the direction of a wireless IC tag varies with different situations and, on top of that, the radio wave outputted from the antenna of a reader/writer also changes with the radio polarization mode in terms of the propagation manner, the reading rate is subject to change according to the combination of the direction of a wireless IC tag and the radio polarization mode as well.

The radio polarization mode includes the linear polarization and the circular polarization. For a linearly polarized wave, the efficiency of receiving the radio wave becomes the best as the antenna of a reader/writer parallely faces a wireless IC tag, and thus the reading rate becomes the highest, whereas the reading becomes completely impossible as one faces the other vertically. Further, for a circularly polarized wave, although the reading is possible regardless of the direction of a wireless IC tag, the reading rate is lower on the whole in comparison with the linearly polarized wave.

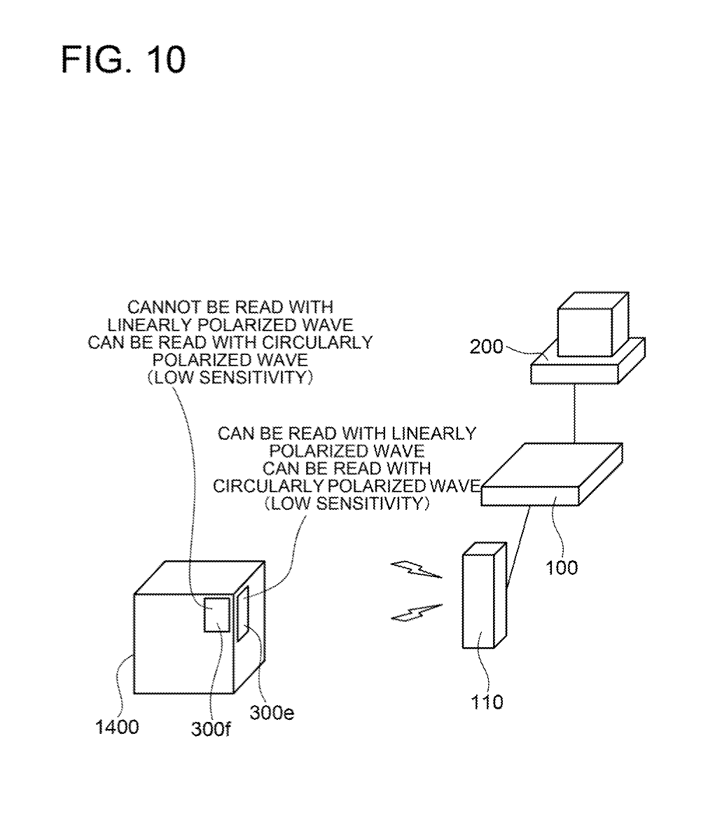

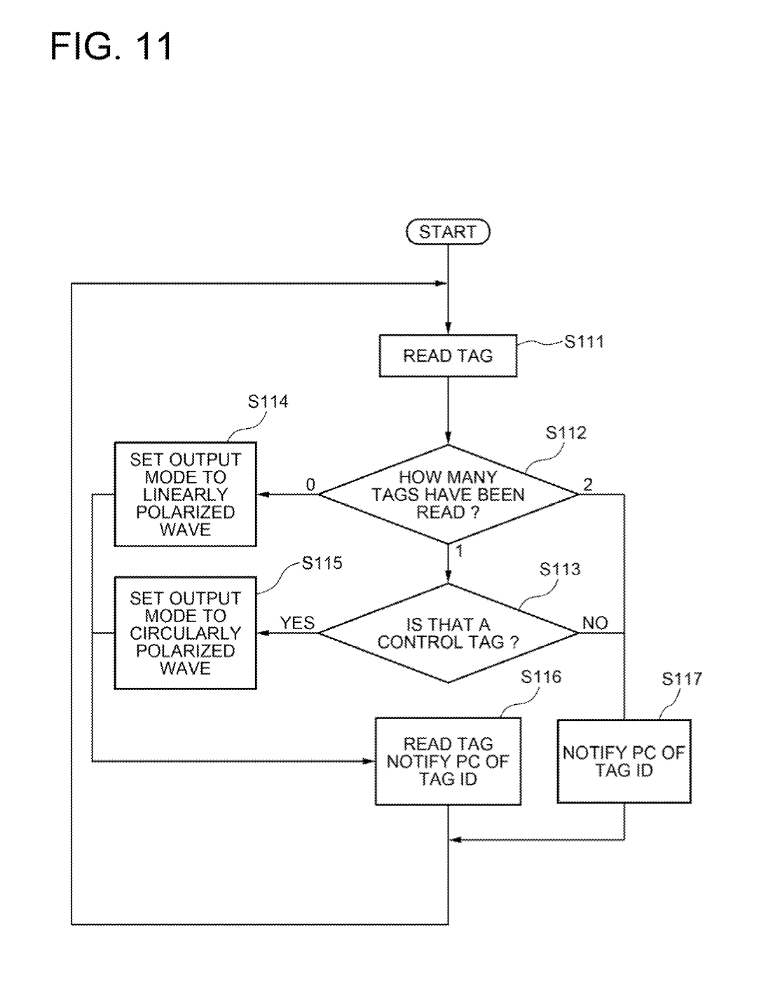

Therefore, the seventh exemplary embodiment utilizes a control tag to control the radio polarization mode of the radio wave outputted from a reader/writer, so as to improve the rate of reading wireless IC tags. Hereinbelow, referring to FIGS. 10 and 11, the seventh exemplary embodiment will be explained.

Referring to FIG. 10, the antenna 110 of a reader/writer 100 has a configuration for outputting a linearly polarized radio wave and a configuration for outputting a circularly polarized radio wave, and allows for switching the radio polarization mode of the output radio wave. Further, a wireless IC tag 300e for authentication and a control tag 300f for controlling the reader/writer 100 are affixed to mutually perpendicular surfaces of an authentication object 1400, respectively. The wireless IC tag 300e has recorded a tag ID for authenticating the authentication object. Further, the control tag 300f has recorded a tag ID (as the IDf) corresponding to the control item “radio polarization mode” and the control content “change to circularly polarized wave”. Further, the behavior correspondence table 160 in the reader/writer 100 has recorded the control item “radio polarization mode” and the control content “change to circularly polarized wave” in association with the tag ID “IDf”. Here, because the wireless IC tag 300e and the control tag 300f are affixed to mutually perpendicular surfaces of the authentication object 1400, if the radio polarization mode of the radio wave outputted from the antenna 110 is of a linearly polarized wave, then it is possible to give rise to such a situation as when the wireless IC tag 300e can be read, the control tag 300f cannot be read; whereas when the control tag 300f can be read, the wireless IC tag 300e cannot be read.

### An Explanation on the Behavior of the Seventh Exemplary Embodiment

Next, the behavior of the seventh exemplary embodiment will be explained in reference to the flowchart of FIG. 11.

In order to read the tag IDs recorded in the wireless IC tag 300e and control tag 300f affixed to the authentication object 1400, the reader/writer 100 outputs a radio wave form the antenna 110 (the step S111). Further, in the seventh exemplary embodiment, the radio polarization mode of the radio wave outputted in the step S111 is supposed to be the same as that of the radio wave outputted last time. However, the radio polarization mode is not limited to this configuration, but may as well be constantly of a linearly polarized wave or constantly of a circularly polarized wave.

Thereafter, the main processing portion 130 in the reader/writer 100 determines whether the tag ID is readable from both of the wireless IC tag 300e and the control tag 300f, or from only one of them, or from none (the step S112).

When the tag ID is readable from both of the wireless IC tag 300e and the control tag 300f, the main processing portion 130 notifies the personal computer 200 of the tag ID read from the wireless IC tag 300e (the step S117). In this manner, the case that the tag ID is readable from both of the wireless 1C tag 300e and the control tag 300f is that, the radio polarization mode is of the circularly polarized wave, or it is of the linearly polarized wave while the antenna 110 does not vertically face the tags 300e and 300f.

Further, when the tag ID is readable from only one of the tags 300e and 300f, the main processing portion 130 determines from which one the tag ID is read (the step 113). Further, the case that the tag ID is readable from only one tag is that the radio polarization mode is of the linearly polarized wave.

Then, when the tag ID is read from the wireless IC tag 300e for authentication (the step S113 is NO), the main processing portion 130 sends the tag ID read from the wireless IC tag 300e to the personal computer 200 (the step S117). On the other hand, when the tag ID “IDf” is read from the control tag 300f, it changes the radio polarization mode of the radio wave outputted from the antenna 110 of the reader/writer 100 to the circularly polarized wave according to the control information with the control item “radio polarization mode” and the control content “change to circularly polarized wave” recorded in the behavior correspondence table 160 in association with the tag ID “IDf” (the step S115). By changing the radio polarization mode to the circularly polarized wave, the rate of reading the wireless IC tag 300e is improved. Thereafter, the main processing portion 130 reads the tag IDs from the tags 300e and 300f, and notifies the personal computer 200 of the tag ID read from the wireless IC tag 300e (the step S116). Further, when the tag ID of the wireless IC tag cannot be read in the step 116, it carries out an error process, for example, to inform the worker and the like of the failure in reading the tag.

Further, when no tag ID is readable from either tag in the step S112, the main processing portion 130 changes the radio polarization mode of the radio wave outputted from the antenna 110 to the linearly polarized wave (the step S114). Changing the radio polarization mode to the linearly polarized wave is for raising the radio wave intensity so as to improve the reading rate. That is, utilizing the circularly polarized radio wave with a low intensity is regarded as the reason why no tag ID could be read in the step 112; therefore, the above process is carried out. Thereafter, the main processing portion 130 reads the tag IDs from the tags 300e and 300f, and notifies the personal computer 200 of the tag ID read from the wireless IC tag 300e (the step S116). Further, if the wireless IC tag 300e cannot be read in the step 116, it carries out an error process.

Further, it is possible to improve the reading rate by applying the seventh exemplary embodiment to the case of reading tag IDs from the wireless IC tags affixed to the authentication objects conveyed by the belt conveyer 800, as shown in FIG. 8.

### An Effect of the Seventh Exemplary Embodiment

According to the seventh exemplary embodiment, in addition to the effect acquired in the first exemplary embodiment, it is possible to acquire another effect that it is possible to improve the rate of reading the wireless IC tag 300e affixed to the authentication object 1400. This is because changing the radio polarization mode is based on the result of reading both of the wireless IC tag 300e, and the control tag 300f which is affixed to the authentication object 1400 too for changing the radio polarization mode, as well as on the control information recorded in the behavior correspondence table 160 for changing the radio polarization mode.

### An Eighth Exemplary Embodiment of the Present Invention

Next, an eighth exemplary embodiment of the present invention will be explained. The eighth exemplary embodiment is characterized by setting up a behavior switching portion and a behavior correspondence table on the personal computer side.

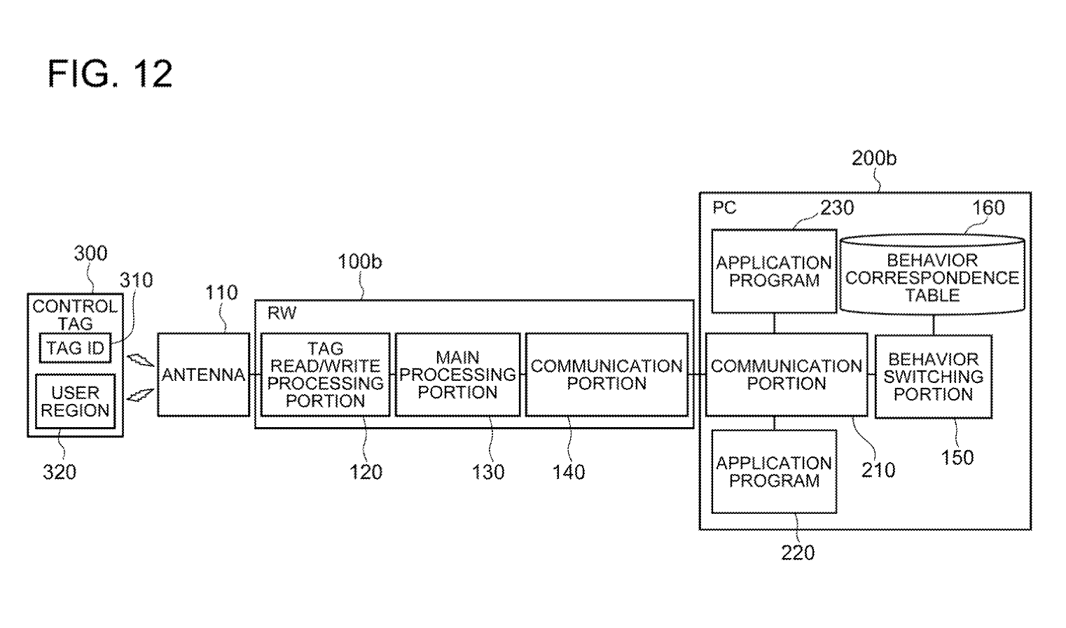

Referring to FIG. 12, a reader/writer control apparatus in accordance with the eighth exemplary embodiment is composed of a reader/writer 100b, a personal computer 200b, and a control tag 300. The reader/writer 100b includes an antenna 110, a tag read/write processing portion 120, a main processing portion 130, and a communication portion 140. The personal computer 200b includes a communication portion 210, application programs 220 and 230, a behavior switching portion 150, and a behavior correspondence table 160.

### An Explanation on the Behavior of the Eighth Exemplary Embodiment

The main processing portion 130 in the reader/writer 100b sends the tag ID read from the control tag 300 via the antenna 110 and the tag read/write processing portion 120 to the personal computer 200b via the communication portion 140. The communication portion 210 in the personal computer 200b passes the tag ID sent from the reader/writer 100b to the behavior switching portion 150. The behavior switching portion 150 searches the control information recorded in association with the tag ID from the behavior correspondence table 160, and then sends the search result including the found control information to the reader/writer 100b via the communication portion 210. On receiving the search result via the communication portion 140, the main processing portion 130 in the reader/writer 100b controls each portion in the reader/writer 100b according to the control information included in the search result.

### An Effect of the Eighth Exemplary Embodiment

According to the eighth exemplary embodiment, in addition to the effect acquired in the first exemplary embodiment, it is possible to acquire another effect that the configuration of the reader/writer can be simplified. This is because the behavior switching portion 150 and the behavior correspondence table 160 are provided in the personal computer 200b.

### A Ninth Exemplary Embodiment of the Present Invention

Next, a ninth exemplary embodiment of the present invention will be explained in detail.

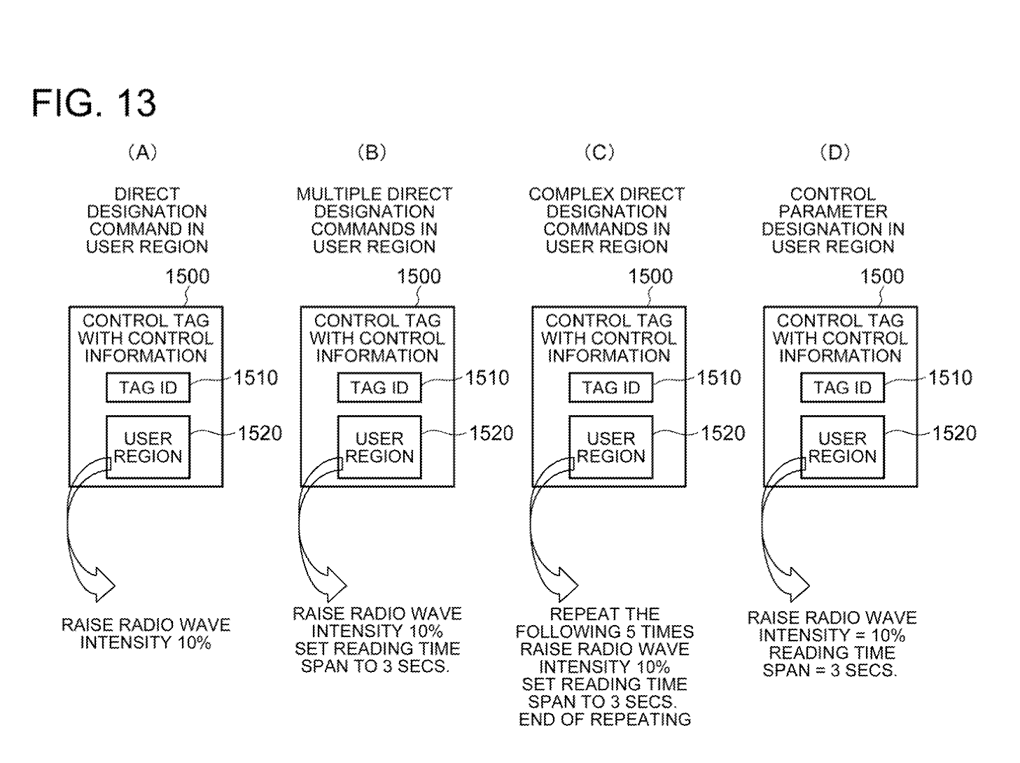

Referring to FIGS. 13A to 13D, a control tag 1500 with control information includes a tag ID region 1510 and a user region 1520. The control tag 1500 with control information is realized by a wireless IC tag.

The user region 1520 has recorded control information including a control item and a control content. For example, the user region 1520 shown in FIG. 13A has recorded the control information “raise radio wave intensity 10%” with the control item “radio wave intensity” and the control content “raise 10%”. Further, the user region 1520 shown in FIG. 13B has recorded two pieces of control information: the control information “raise radio wave intensity 10%” with the control item “radio wave intensity” and the control content “raise 10%”, and the control information “set reading time span to three seconds” with the control item “reading time span” and the control content “set to three seconds”. Further, the user region 1520 shown in FIG. 13C has recorded the control information for instructing the processing portion to repeat five times the process of raising the radio wave intensity by 10% and the process of setting the reading time span to three seconds. Further, the user region 1520 shown in FIG. 13D has recorded the control information of the format to designate the parameter values, including the control information for setting 10% for the radio wave intensity, and the control information for setting three seconds for the reading time span.

The tag ID region 1510 has recorded a tag ID corresponding to the control information of instruction to control the operation of the reader/writer 100 according to the control information recorded in the user region 1520. In the ninth exemplary embodiment, the tag ID is recorded as “IDg”. Further, as shown in FIG. 2, the behavior correspondence table 160 in the reader/writer 100 has recorded the control information with the control item being “user region” and the control content being “follow the contents of user region” in association with the tag ID “IDg”.

### An Explanation on the Behavior of the Ninth Exemplary Embodiment

On reading the tag ID “IDg” and the control information “raise radio wave intensity 10%” from the control tag 1500 with control information shown in FIG. 13A, for example, via the antenna 110 and tag read/write processing portion 120, the main processing portion 130 in the reader/writer 100 shown in FIG. 1 passes the tag ID “IDg” to the behavior switching portion 150. The behavior switching portion 150 then searches the control information with the control item “user region” and the control content “follow the contents of user region” recorded in association with the tag ID “IDg” from the behavior correspondence table 160, and returns the search result to the main processing portion 130. By virtue of this, the main processing portion 130 controls each portion in the reader/writer 100 according to the already read control information “raise radio wave intensity 10%” to raise the radio wave intensity outputted from the antenna 110 by 10%.

Further, on reading the tag ID “IDg” and the control information “raise radio wave intensity 10%, set reading time span to three seconds” from the control tag 1500 with control information shown in FIG. 13B, for example, the main processing portion 130 in the reader/writer 100 passes the tag ID “IDg” to the behavior switching portion 150. By virtue of this, the behavior switching portion 150 then searches the control information recorded in association with the tag ID “IDg” from the behavior correspondence table 160, and returns the search result to the main processing portion 130. Then, the main processing portion 130 controls each portion in the reader/writer 100 according to the already read control information “raise radio wave intensity 10%, set reading time span to three seconds” to raise the radio wave intensity outputted from the antenna 110 by 10%, as well as to set the reading time span to three seconds.

### An Effect of the Ninth Exemplary Embodiment

According to the ninth exemplary embodiment, in addition to the effect acquired in the first exemplary embodiment, it is possible to acquire another effect that the operation of the reader/writer 100 can also be controlled by the control information recorded in the control tag 1500 with control information. This is because the behavior correspondence table 160 has recorded the control information of instruction to control the operation of the reader/writer 100 according to the control information recorded in the control tag 1500 with control information.

[Supplementary Notes]

The whole or part of the exemplary embodiments disclosed above can be described as, but not limited to, the following supplementary notes.

(Supplementary Note 1)

A reader/writer control apparatus comprising:

a behavior correspondence table having recorded a plurality of pieces of control information including respectively a control item and a control content for the control item in association with a unique tag ID corresponding to each piece of the control information;

a search portion for searching from the behavior correspondence table, the control information recorded in association with a tag ID read by a tag read/write processing portion from a special control tag configured by a wireless IC tag having recorded the unique tag ID corresponding to the control information and being utilized for controlling the operation of a reader/writer including the tag read/write processing portion for reading and writing data from and to a wireless IC tag; and

a processing portion for controlling the operation of the reader/writer according to the control information searched by the search portion.

(Supplementary Note 2)

The reader/writer control apparatus according to Supplementary Note 1, wherein the behavior correspondence table has recorded control information of instruction to control the operation of the reader/writer according to control information recorded in a special control tag with control information, in association with a tag ID recorded in the special control tag with control information having recorded the unique tag ID and the control information; and the search portion searches from the behavior correspondence table, the control information recorded in association with the tag ID read by the tag read/write processing portion from the special control tag with control information.

(Supplementary Note 3)

The reader/writer control apparatus according to Supplementary Note 1 or 2, wherein the plurality of pieces of control information recorded in the behavior correspondence table include those with control items different from each other.

(Supplementary Note 4)

The reader/writer control apparatus according to any one of Supplementary Notes 1 to 3, wherein if the behavior correspondence table has not recorded the tag ID read by the tag read/write processing portion from the wireless IC tag, then the search portion determines the wireless IC tag as a wireless IC tag for authenticating an authentication object.

(Supplementary Note 5)

The reader/writer control apparatus according to any one of Supplementary Notes 1 to 4, wherein the special control tag has not recorded authentication data for authenticating an authentication object.

(Supplementary Note 6)

The reader/writer control apparatus according to any one of Supplementary Notes 1 to 5, wherein the control information is to switch a destination to be notified of authentication data read by the tag read/write processing portion from the wireless IC tag.

(Supplementary Note 7)

The reader/writer control apparatus according to any one of Supplementary Notes 1 to 6, wherein the control information includes at least one piece of information for controlling intensity of a radio wave outputted from the reader/writer, information for controlling a radio polarization mode of a radio wave outputted from the reader/writer, information for prohibiting an output of a radio wave from the reader/writer, and information for controlling reading time span of the reader/writer.

(Supplementary Note 8)

The reader/writer control apparatus according to any one of Supplementary Notes 1 to 7 further comprising a modification unit for modifying contents of the behavior correspondence table according to user's instruction.

(Supplementary Note 9)

A special control tag configured by a wireless IC tag which has recorded a unique tag ID corresponding to a control item and a control content for the control item, and which is utilized for controlling an operation of a reader/writer for reading and writing data from and to a wireless IC tag.

(Supplementary Note 10)

A reader/writer control method for controlling an operation of a reader/writer including a tag read/write processing portion for reading and writing data from and to a wireless IC tag, the method comprising:

reading a tag ID from a special control tag configured by a wireless IC tag which has recorded a unique tag ID corresponding to control information including a control item and a control content for the control item, and which is utilized for controlling the operation of the reader/writer;

searching the control information recorded in association with the tag ID read from the special control tag, in a behavior correspondence table having recorded a plurality of pieces of the control information in association with the unique tag ID corresponding to each piece of the control information; and

controlling the operation of the reader/writer according to the searched control information.

(Supplementary Note 11)

A computer-readable medium storing a program comprising instructions for causing a computer to carry out a process for controlling an operation of a reader/writer including a tag read/write processing portion for reading and writing data from and to a wireless IC tag, the process comprising:

reading a tag ID from a special control tag configured by a wireless IC tag which has recorded a unique tag ID corresponding to control information including a control item and a control content for the control item, and which is utilized for controlling the operation of the reader/writer;

searching the control information recorded in association with the tag ID read from the special control tag, in a behavior correspondence table having recorded a plurality of pieces of the control information in association with the unique tag ID corresponding to each piece of the control information; and

controlling the operation of the reader/writer according to the searched control information.

(Supplementary Note 12)

A reader/writer control apparatus comprising:

a storage means for storing a behavior correspondence table having associated control information including a control item and a control content for the control item with a unique tag ID corresponding to the control information;

a search means for searching from the behavior correspondence table, the control information recorded in association with a tag ID read by a tag read/write processing means from a special control tag configured by a wireless IC tag having recorded the unique tag ID corresponding to the control information and being utilized for controlling the operation of a reader/writer including the tag read/write processing means for reading and writing data from and to a wireless IC tag; and

a processing means for controlling an operation of the reader/writer according to the control information searched by the search means.

The present invention is applicable to systems utilizing readers/writers for reading and writing data from and to wireless IC tags.

1. A reader/writer control apparatus comprising:
a behavior correspondence table having recorded a plurality of pieces of control information including respectively a control item and a control content for the control item in association with a unique tag ID corresponding to each piece of the control information;
a search portion for searching from the behavior correspondence table, the control information recorded in association with a tag ID read by a tag read/write processing portion from a special control tag configured by a wireless IC tag having recorded the unique tag ID corresponding to the control information and being utilized for controlling the operation of a reader/writer including the tag read/write processing portion for reading and writing data from and to a wireless IC tag; and
a processing portion for controlling the operation of the reader/writer according to the control information searched by the search portion.

2. The reader/writer control apparatus according to claim 1, wherein the behavior correspondence table has recorded control information of instruction to control the operation of the reader/writer according to control information recorded in a special control tag with control information, in association with a tag ID recorded in the special control tag with control information having recorded the unique tag ID and the control information; and the search portion searches from the behavior correspondence table, the control information recorded in association with the tag ID read by the tag read/write processing portion from the special control tag with control information.

3. The reader/writer control apparatus according to claim 1, wherein the plurality of pieces of control information recorded in the behavior correspondence table include those with control items different from each other.

4. The reader/writer control apparatus according to claim 1, wherein if the behavior correspondence table has not recorded the tag ID read by the tag read/write processing portion from the wireless IC tag, then the search portion determines the wireless IC tag as a wireless IC tag for authenticating an authentication object.

5. The reader/writer control apparatus according to claim 1, wherein the special control tag has not recorded authentication data for authenticating an authentication object.

6. The reader/writer control apparatus according to claim 1, wherein the control information is to switch a destination to be notified of authentication data read by the tag read/write processing portion from the wireless IC tag.

7. The reader/writer control apparatus according to claim 1, wherein the control information includes at least one piece of information for controlling intensity of a radio wave outputted from the reader/writer, information for controlling a radio polarization mode of a radio wave outputted from the reader/writer, information for prohibiting an output of a radio wave from the reader/writer, and information for controlling reading time span of the reader/writer.

8. The reader/writer control apparatus according to claim 1 further comprising a modification unit for modifying contents of the behavior correspondence table according to user's instruction.

9. A special control tag configured by a wireless IC tag which has recorded a unique tag ID corresponding to a control item and a control content for the control item, and which is utilized for controlling an operation of a reader/writer for reading and writing data from and to a wireless IC tag.

10. A reader/writer control method for controlling an operation of a reader/writer including a tag read/write processing portion for reading and writing data from and to a wireless IC tag, the method comprising:
reading a tag ID from a special control tag configured by a wireless IC tag which has recorded a unique tag ID corresponding to control information including a control item and a control content for the control item, and which is utilized for controlling the operation of the reader/writer;
searching the control information recorded in association with the tag ID read from the special control tag, in a behavior correspondence table having recorded a plurality of pieces of the control information in association with the unique tag ID corresponding to each piece of the control information; and
controlling the operation of the reader/writer according to the searched control information.
